(19) United States
(12) Patent Application Publication
(10) Pub. No.: US 2012/0328959 A1
(43) Pub. Date: Dec. 27, 2012

(54) ALL SOLID STATE SECONDARY BATTERY AND METHOD FOR PRODUCING SAME

(75) Inventors: Takeshi Hayashi, Nagaokakyo-shi (JP); Masutaka Ouchi, Nagaokakyo-shi (JP); Kunio Nishida, Nagaokakyo-shi (JP); Takafumi Iwaguchi, (US); Hitomi Nishida, (US); Makoto Yoshioka, Nagaokakyo-shi (JP)

(73) Assignee: Murata Manufacturing Co., Ltd., Nagaokakyo-shi (JP)

(21) Appl. No.: 13/603,526

(22) Filed: Sep. 5, 2012

Related U.S. Application Data
(63) Continuation of application No. PCT/JP2011/054436, filed on Feb. 28, 2011.

(30) Foreign Application Priority Data
Mar. 9, 2010 (JP) 2010-051700

(51) Int. Cl. H01M 10/0562; H01M 6/00

(52) U.S. Cl. 429/319; 29/623.1

(57) ABSTRACT

An all solid state secondary battery configured with the use of a NASICON-type compound for a solid electrolyte and a lithium-containing manganese oxide for a positive electrode active material. The all solid state secondary battery includes a positive electrode layer and a solid electrolyte layer, in which a positive electrode active material constituting the positive electrode layer contains a compound represented by the general formula LiₓM_{y}Mn_{z}O₄, wherein 1≦x≦1.33, 0≦y≦0.5, and 1.67−y≦z≦2−y, and M is at least one element selected from the group consisting of Ni, Co, Al, and Cr, and a solid electrolyte constituting the solid electrolyte layer contains a compound represented by the general formula Li_{1+w}Al_{w}Ge_{2-w}(PO₄)₃, wherein 0≦w≦1.

### CROSS REFERENCE TO RELATED APPLICATIONS

The present application is a continuation of International application No. PCT/JP2011/054436, filed Feb. 28, 2011, which claims priority to Japanese Patent Application No. 2010-051700, filed Mar. 9, 2010, the entire contents of each of which are incorporated herein by reference.

### FIELD OF THE INVENTION

The present invention generally relates to an all solid state secondary battery and a method for producing the all solid state secondary battery, and more particularly, relates to an electrode active material which has a NASICON structure (hereinafter, referred to as a NASICON type), and an all solid state secondary battery including the electrode active material.

### BACKGROUND OF THE INVENTION

In recent years, batteries, in particular, secondary batteries have been used as power sources for portable electronic devices such as cellular phones and portable personal computers. Among the secondary batteries, rechargeable lithium ion secondary batteries which are high in energy density have been used.

In these lithium ion secondary batteries, electrolytes (electrolyte solutions) such as organic solvents have been used conventionally as a medium for moving ions.

However, the lithium ion secondary batteries configured described above are at risk for the leakage of the electrolyte solution. In addition, the organic solvent and the like for use in the electrolyte solutions are combustible substances. For this reason, the safety of the batteries has been demanded to be further enhanced.

Therefore, the use of solid electrolytes as an electrolyte in place of the organic solvent based electrolyte solution has been proposed as one measure for enhancing the safety of lithium ion secondary batteries. In particular, NASICON-type compounds are ion conductors which can carry lithium ions at high speed, and the development of all solid state secondary batteries has been thus advanced which use these compounds for solid electrolytes.

For example, Japanese Patent Application Laid-Open No. 2007-5279 (hereinafter, referred to as Patent Document 1) proposes an all solid state lithium secondary battery which have components all composed of solids with the use of an incombustible solid electrolyte. As an example of this all solid state lithium secondary battery, a battery is disclosed which uses, for a solid electrolyte, Li_{1.3}Al_{0.3}Ti_{1.7}(PO₄)₃ or LiTi₂(PO₄)₃ as an example of NASICON-type compounds represented by the general formula Li_{1+X}M^{III}_{X}Ti^{IV}_{2-X}(PO₄)₃ (in the formula, M^{III} is at least one metal ion selected from the group consisting of Al, Y, Ga, In, and La, and X satisfies 0≦X≦0.6), uses, for a positive electrode active material, LiCoPO₄ or LiMnPO₄ as an example of compounds represented by the general formula LiMPO₄ (in the formula, M is at least one selected from the group consisting of Mn, Fe, Co, and Ni), and uses a metal lithium as a negative electrode.

Patent Document 1: Japanese Patent Application Laid-Open No. 2007-5279

### SUMMARY OF THE INVENTION

However, as described in Patent Document 1, it is not possible to discharge the battery which is configured with the use of the NASICON-type compound for the solid electrolyte, and LiMn₂O₄ as an example of lithium-containing manganese oxides for the positive electrode active material. This is because a heat treatment carried out in the process for producing the battery generates an impurity layer at the interface between the solid electrolyte and the positive electrode active material.

The all solid state secondary battery configured with the use of a lithium-containing manganese oxide for the positive electrode active material has the advantage that a high potential can be achieved with a reduction in production cost. In order to make use of this advantage, there has been a need for an all solid state secondary battery configured with the use of a NASICON-type compound for a solid electrolyte and a lithium-containing manganese oxide for a positive electrode active material.

Therefore, an object of the present invention is to provide an all solid state secondary battery configured with the use of a NASICON-type compound for a solid electrolyte and a lithium-containing manganese oxide for a positive electrode active material.

The all solid state secondary battery according to the present invention is an all solid state secondary battery including a positive electrode layer and a solid electrolyte layer, wherein a positive electrode active material constituting the positive electrode layer contains a compound represented by the general formula LiₓM_{y}Mn_{z}O₄ (in the formula, x, y, and z respectively satisfy 1≦x≦1.33, 0≦y≦0.5, and 1.67−y≦z≦2−y, and M is at least one element selected from the group consisting of Ni, Co, Al, and Cr), and a solid electrolyte constituting the solid electrolyte layer contains a compound represented by the general formula Li_{1+w}Al_{w}Ge_{2-w}(PO₄)₃ (in the formula, w satisfies 0≦w≦1).

In the all solid state secondary battery according to the present invention, the positive electrode active material preferably contains a compound represented by LiMn₂O₄.

In the all solid state secondary battery according to the present invention, the positive electrode active material preferably contains a compound represented by LiNi_{0.5}Mn_{1.5}O₄.

In the all solid state secondary battery according to the present invention, the positive electrode layer and the solid electrolyte layer are preferably joined by sintering.

In addition, in the all solid state secondary battery according to the present invention, the positive electrode active material preferably contains at least one metal selected from the group consisting of aluminum, yttrium, gallium, indium, and lanthanum.

Furthermore, in the all solid state secondary battery according to the present invention, the solid electrolyte preferably contains silicon.

A method for producing the all solid state secondary battery according to the present invention includes the following steps.

(A) A step of forming a positive electrode layer containing, as a positive electrode active material, a compound represented by the general formula LiₓM_{y}Mn_{z}O₄ (in the formula, x, y, and z respectively satisfy 1≦x≦1.33, 0≦y≦0.5, and 1.67−y≦z≦2−y, and M is at least one element selected from the group consisting of Ni, Co, Al, and Cr).

(B) A step of forming a solid electrolyte layer containing a compound represented by the general formula Li_{1+w}Al_{w}Ge_{2-w}(PO₄)₃ (in the formula, w satisfies 0≦w≦1).

(C) A firing step of stacking the positive electrode layer and the solid electrolyte layer, and joining the layers by sintering.

In the method for producing the all solid state secondary battery according to the present invention, the positive electrode layer and the solid electrolyte layer are preferably joined by sintering at a temperature of 500° C. or more and 700° C. or less in the firing step.

The use of the NASICON-type lithium-germanium containing compound for the solid electrolyte and of the spinel-type lithium-containing manganese oxide for the positive electrode active material can provide a rechargeable all solid state secondary battery.

### BRIEF EXPLANATION OF THE DRAWINGS

FIG. 1 is a cross-sectional view schematically illustrating a cross-section structure of an all solid state secondary battery as an embodiment of the present invention.

FIG. 2 is a perspective view schematically illustrating an all solid state secondary battery as an embodiment of the present invention.

FIG. 3 is a perspective view schematically illustrating an all solid state secondary battery as another embodiment of the present invention.

FIG. 4 is a diagram showing an X-ray diffraction pattern for a positive electrode sheet of an all solid state secondary battery prepared according to an example of the present invention.

FIG. 5 is a diagram showing an X-ray diffraction pattern for a positive electrode sheet of an all solid state secondary battery prepared according to a comparative example of the present invention.

### DETAILED DESCRIPTION OF THE INVENTION

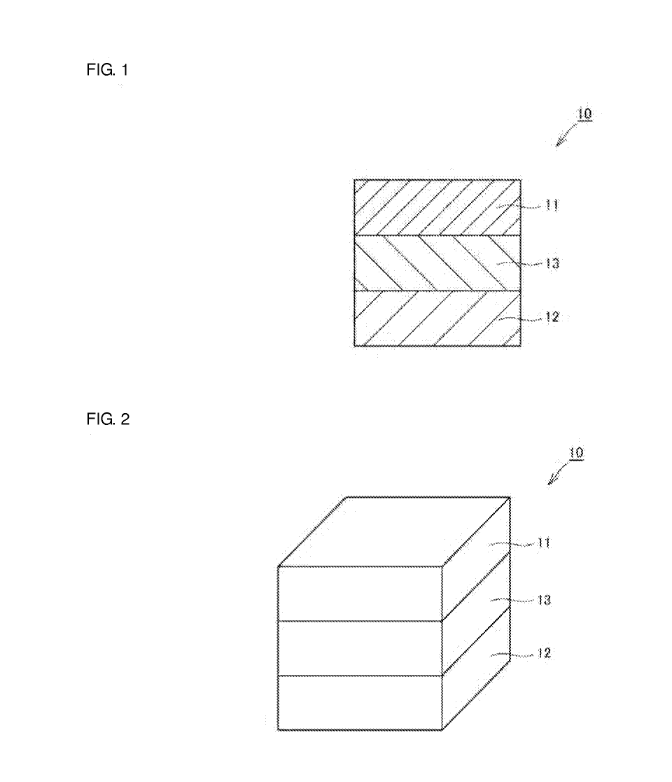

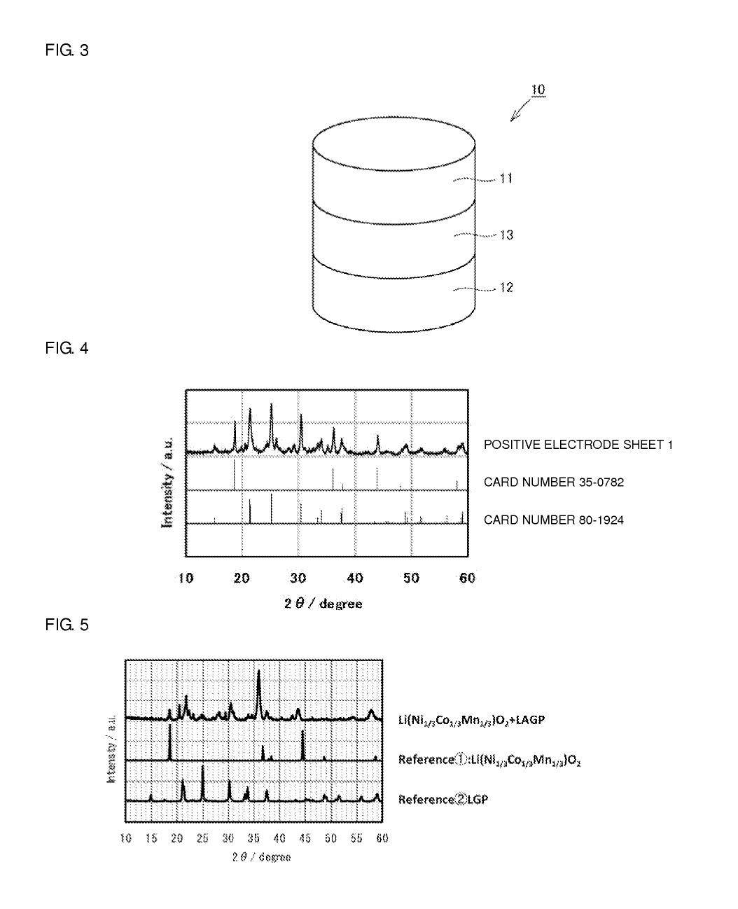

As shown in FIG. 1, an all solid state secondary battery 10 according to the present invention includes a positive electrode layer 11, a solid electrolyte layer 13, and a negative electrode layer 12. As shown in FIG. 2, as an embodiment of the present invention, the all solid state secondary battery 10 is formed in a cuboid shape, and composed of a laminated body of multiple plate-shaped layers which have rectangular flat surfaces. In addition, as shown in FIG. 3, as another embodiment of the present invention, the all solid state secondary battery 10 is formed in a circular cylindrical shape, and composed of a laminated body of multiple disk-shaped layers. The solid electrolyte contains a compound represented by the general formula Li_{1+w}Al_{w}Ge_{2-w}(PO₄)₃ (in the formula, w satisfies 0≦w≦1), that is, a NASICON-type lithium-germanium containing compound. The positive electrode active material contains a compound represented by the general formula LiₓM_{y}Mn_{z}O₄ (in the formula, x, y, and z respectively satisfy 1≦x≦1.33, 0≦y≦0.5, and 1.67−y≦z≦2−y, and M is at least one element selected from the group consisting of Ni, Co, Al, and Cr), that is, a spinel-type lithium-containing manganese compound. The positive electrode active material containing, as the M, at least one element selected from the group consisting of Ni, Co, Al, and Cr allows the potential of the battery to be increased. In particular, the positive electrode active material containing Ni as the M can further enhance the effect of increasing the potential of the battery. The spinel-type lithium-containing manganese oxide is preferably LiMn₂O₄ or LiNi_{0.5}Mn_{1.5}O₄. The positive electrode layer 11 is composed of a mixture of the solid electrolyte and positive electrode active material described above. It is to be noted that the negative electrode layer 12 may be formed from a metal lithium, or may be formed with the use of, as a negative electrode active material, a graphite-lithium compound, a lithium alloy such as Li—Al, a NASICON-type lithium-containing phosphate compound such as Li₃V₂(PO₄)₃ or Li₃Fe₂(PO₄)₃, or an oxide such as Li₄Ti₅O₁₂.

As just described, even in the case of using the spinel-type lithium-containing manganese oxide for the positive electrode active material, the NASICON-type lithium-germanium containing compound is used for the solid electrolyte in the present invention, and it is thus possible to charge and discharge the battery as an all solid state secondary battery. For this reason, the advantages of a high potential and a reduction in production cost can be achieved by using the spinel-type lithium-containing manganese oxide for the positive electrode active material.

In addition, the spinel-type lithium-containing manganese oxide used in the positive electrode active material in the all solid state secondary battery according to the present invention has a higher true density as compared with phosphate compounds such as LiMnPO₄ used as a positive electrode active material typically in the case of using a NASICON-type lithium-germanium containing compound for a solid electrolyte in an all solid state secondary battery. For this reason, when batteries which have relatively high volumetric energy densities, or batteries which have the same energy density are compared with each other, a low-profile and small-sized battery can be prepared in the case of using the spinel-type lithium-containing manganese oxide for a positive electrode active material, than in the case of using the phosphate compound for a positive electrode active material.

Furthermore, the use of the spinel-type lithium-containing manganese oxide for the positive electrode active material and of the NASICON-type lithium-germanium containing compound for the solid electrolyte generates no impurity layer at the interface between the positive electrode layer 11 and the solid electrolyte layer 13, even when the positive electrode layer 11 and the solid electrolyte layer 13 are configured to be joined by sintering as an embodiment of the all solid state secondary battery 10 according to the present invention. For this reason, a laminated body of the positive electrode layer 11 and the solid electrolyte layer 13 can be formed by sintering in an integrated fashion. Therefore, it becomes possible to reduce the production cost of the all solid state secondary battery.

Furthermore, in a preferred embodiment of the all solid state secondary battery according to the present invention, the positive electrode active material contains at least one metal selected from the group consisting of aluminum, yttrium, gallium, indium, and lanthanum.

This positive electrode active material containing aluminum or the like can suppress manganese elution in the case of operating the battery at high temperature and high voltage. This suppression of manganese elution can remedy the cycle degradation of the battery.

In a preferred embodiment of the all solid state secondary battery according to the present invention, the solid electrolyte contains silicon.

This solid electrolyte containing silicon can substitute a P site with the silicon (Si) to improve the lithium ion conduction in the electrolyte.

In an embodiment of the method for producing the all solid state secondary battery according to the present invention, a positive electrode layer is first formed, which contains, as a positive electrode active material, a compound represented by the general formula LiₓM_{y}Mn_{z}O₄ (in the formula, x, y, and z respectively satisfy 1≦x≦1.33, 0≦y≦0.5, and 1.67−y≦z≦2−y, and M is at least one element selected from the group consisting of Ni, Co, Al, and Cr). Next, a solid electrolyte layer 13 is formed which contains a compound represented by the general formula Li_{1+w}Al_{w}Ge_{2-w}(PO₄)₃ (in the formula, w satisfies 0≦w≦1). Then, the positive electrode layer 11 and the solid electrolyte layer 13 are stacked, and joined by firing.

The positive electrode layer 11 and the solid electrolyte layer 13 can be formed by firing in an integrated fashion in this way, thus making it possible to produce the all solid state secondary battery 10 according to the present invention at low cost.

In a preferred embodiment of the method for producing the all solid state secondary battery according to the present invention, the positive electrode layer 11 and the solid electrolyte layer 13 are joined by sintering at a temperature of 500° C. or more and 700° C. or less in the firing step.

The sintering of the positive electrode layer 11 and solid electrolyte layer 13 at a temperature of 500° C. or more and 700° C. or less can easily remove a binder, and prevent over sintering more effectively.

Next, examples of the present invention will be described specifically. It is to be noted that the following examples are by way of example, and the present invention is not to be considered limited to the following examples.

### EXAMPLES

Examples 1 to 3 and Comparative Examples 1 to 2 will be described below with reference to all solid state secondary batteries prepared with the use of various types of positive electrode active materials, solid electrolytes, and negative electrode active materials.

### Example 1

First, in order to prepare an all solid state secondary battery, a positive electrode sheet and a solid electrolyte sheet were prepared in the following way.

### <Preparation of Positive Electrode Sheet and Solid Electrolyte Sheet>

Polyvinyl alcohol as a binder was dissolved in a solvent to prepare a binder solution. This binder solution was mixed with, as a positive electrode active material, a crystal powder of a lithium manganese oxide (LiMn₂O₄: hereinafter, referred to as an LMO) as an example of spinel-type lithium-containing manganese oxides, thereby preparing a positive electrode active material slurry. The mixing ratio between the LMO and the polyvinyl alcohol was adjusted to 70:30 in terms of parts by weight.

The binder solution was mixed with, as a solid electrolyte, a powder of Li_{1.5}Al_{0.5}Ge_{0.5}(PO₄)₃ (hereinafter, referred to as LAGP) as an example of NASICON-type lithium-germanium containing compounds, thereby preparing a solid electrolyte slurry. The mixing ratio between the LAGP and the polyvinyl alcohol was adjusted to 70:30 in terms of parts by weight.

The thus obtained positive electrode active material slurry and solid electrolyte slurry were mixed so that the mixing ratio between the LMO and the LAGP was 50:50 in terms of parts by weight, thereby preparing a positive electrode slurry.

The obtained positive electrode slurry and solid electrolyte slurry were respectively formed by a doctor blade method into a thickness of 50 μm to prepare compacts (green sheets) of: a positive electrode sheet and a solid electrolyte sheet.

Next, the characteristics of the obtained positive electrode sheet were evaluated in the following way.

### <Evaluation of Positive Electrode Sheet>

The positive electrode sheet was subjected to firing at a temperature of 500° C. for 2 hours under an oxygen gas atmosphere to remove the polyvinyl alcohol, and then to firing at a temperature of 600° C. for 2 hours under a nitrogen gas atmosphere to prepare a positive electrode sheet as a sintered body.

An X-ray diffractometer (XRD) was used to measure an X-ray diffraction pattern for the positive electrode sheet as a sintered body under the conditions of a scan speed: 1.0°/min and a measurement angle range: 10° to 60°. FIG. 4 shows the measured X-ray diffraction pattern (positive electrode sheet 1) for the positive electrode sheet. FIG. 4 together shows the X-ray diffraction pattern from the JCPDS (Joint Committee on Powder Diffraction Standards) card (card No: 35-0782) on a lithium manganese oxide (LiMn₂O₄) as a spinel-type lithium containing manganese oxide, and the X-ray diffraction pattern (card No: 80-1924) from the JCPDS card on LiGe₂(PO₄)₃ as a NASICON-type lithium-germanium containing phosphate compound.

From FIG. 4, it has been confirmed that the X-ray diffraction pattern for the positive electrode sheet 1 as a sintered body almost agrees with the X-ray diffraction patterns for the LiMn₂O₄ and LiGe₂(PO₄)₃, and the LMO and the LAGP can thus maintain their skeletons without disappearing due to any solid-phase reaction in the positive electrode sheet 1 as a sintered body.

The thus obtained compacts of the solid electrolyte sheet and positive electrode sheet were used to prepare an all solid state secondary battery.

### <Preparation of Solid State Battery>

The positive electrode sheet cut into a circular shape of 12 mm in diameter was stacked on one surface of the solid electrolyte sheet cut into a circular shape of 12 mm in diameter, and subjected to thermocompression bonding by applying a pressure of 1 ton at a temperature of 80° C., thereby preparing a positive electrode-electrolyte laminated body as a compact.

This laminated body was subjected to firing at a temperature of 500° C. for 2 hours under an oxygen gas atmosphere to remove the polyvinyl alcohol, and then to firing at a temperature of 600° C. for 2 hours under a nitrogen gas atmosphere to join the positive electrode layer and the solid electrolyte layer by sintering. In this way, a positive electrode-electrolyte laminated body was prepared as a sintered body.

The positive electrode-electrolyte laminated body as a sintered body was dried at a temperature of 100° C. to remove the moisture, a gel electrolyte of a polymethylmethacrylate resin (PMMA) was then applied onto a metal lithium plate as a negative electrode, and the positive electrode-electrolyte laminated body as a sintered body and the metal lithium plate were stacked so that the electrolyte-side surface of the positive electrode-electrolyte laminated body was brought into contact with the application surface, and subjected to sealing with a 2032-type coin cell to prepare a solid-state battery.

The characteristics of the obtained solid-state battery were evaluated in the following way.

### <Evaluation of Solid State Battery>

As a result of applying three charge-discharge cycles at a constant current and a constant voltage to the solid-state battery at a current density of 200 μA/cm² in a voltage range of 3.0 to 4.5 V, it has been confirmed that it is possible to charge and discharge the battery. The first discharge capacity was 98 mAh/g, whereas the discharge capacity in the third cycle was 94 mAh/g.

### Example 2

First, in order to prepare an all solid state secondary battery, a positive electrode sheet and a solid electrolyte sheet were prepared in the following way.

### <Preparation of Positive Electrode Sheet and Solid Electrolyte Sheet>

Polyvinyl alcohol as a binder was dissolved in a solvent to prepare a binder solution. This binder solution was mixed with, as a positive electrode active material, a crystal powder of LiNi_{0.5}Mn_{1.5}O₄: hereinafter, referred to as LNMO) as an example of spinel-type lithium-containing manganese oxides, thereby preparing a positive electrode active material slurry. The mixing ratio between the LNMO and the polyvinyl alcohol was adjusted to 70:30 in terms of parts by weight.

The binder solution was mixed with a powder of LAGP as an example of NASICON-type lithium-germanium containing compounds, thereby preparing a solid electrolyte slurry. The mixing ratio between the LAGP and the polyvinyl alcohol was adjusted to 70:30 in terms of parts by weight.

The thus obtained positive electrode active material slurry and solid electrolyte slurry were mixed so that the mixing ratio between the LNMO and the LAGP was 50:50 in terms of parts by weight, thereby preparing a positive electrode slurry.

The obtained positive electrode slurry and solid electrolyte slurry were respectively formed by a doctor blade method into a thickness of 50 μm to prepare compacts (green sheets) of: a positive electrode sheet and a solid electrolyte sheet.

The thus obtained compacts of the solid electrolyte sheet and positive electrode sheet were used to prepare an all solid state secondary battery.

### <Preparation of Solid State Battery>

The positive electrode sheet cut into a circular shape of 12 mm in diameter was stacked on one surface of the solid electrolyte sheet cut into a circular shape of 12 mm in diameter, and subjected to thermocompression bonding by applying a pressure of 1 ton at a temperature of 80° C., thereby preparing a positive electrode-electrolyte laminated body as a compact.

This laminated body was subjected to firing at a temperature of 500° C. for 2 hours under an oxygen gas atmosphere to remove the polyvinyl alcohol, and then to firing at a temperature of 600° C. for 2 hours under a nitrogen gas atmosphere to join the positive electrode layer and the solid electrolyte layer by sintering. In this way, a positive electrode-electrolyte laminated body was prepared as a sintered body.

The positive electrode-electrolyte laminated body as a sintered body was dried at a temperature of 100° C. to remove the moisture, a gel electrolyte of a polymethylmethacrylate resin (PMMA) was then applied onto a metal lithium plate as a negative electrode, and the positive electrode-electrolyte laminated body as a sintered body and the metal lithium plate were stacked so that the electrolyte-side surface of the positive electrode-electrolyte laminated body was brought into contact with the application surface, and subjected to sealing with a 2032-type coin cell to prepare a solid-state battery.

The characteristics of the obtained solid-state battery were evaluated in the following way.

### <Evaluation of Solid State Battery>

As a result of applying three charge-discharge cycles at a constant current and a constant voltage to the solid-state battery at a current density of 100 μA/cm² in a voltage range of 3.0 to 5.0 V, it has been confirmed that it is possible to charge and discharge the battery. The first discharge capacity was 130 mAh/g, whereas the discharge capacity in the third cycle was 128 mAh/g. The positive electrode active material containing nickel (Ni) made it possible to increase the voltage, and it was thus possible to charge and discharge the battery even in the high voltage range of 3.0 to 5.0 V.

### Example 3

In Example 3, in place of the metal lithium plate used as a negative electrode in Example 1, Li₃V₂(PO₄)₃ (hereinafter, referred to as LVP) as an example of NASICON-type lithium-containing phosphate compounds was used for a negative electrode active material to prepare a compact of a negative electrode sheet by the same method as in the case of the positive electrode sheet according to Example 1. This compact of the negative electrode sheet, and the compacts of the solid electrolyte sheet and positive electrode sheet prepared in Example 1 were used to prepare an all solid state secondary battery.

### <Preparation of Solid State Battery>

In the same way as in Example 1, the positive electrode sheet cut into a circular shape of 12 mm in diameter was stacked on one surface of the solid electrolyte sheet cut into a circular shape of 12 mm in diameter, and subjected to thermocompression bonding by applying a pressure of 1 ton at a temperature of 80° C. Furthermore, the negative electrode sheet cut into a circular shape of 12 mm in diameter was stacked on the opposite surface of the solid electrolyte sheet, and subjected to thermocompression bonding by applying a pressure of 1 ton at a temperature of 80° C., thereby preparing a battery laminated body as a compact.

This laminated body was subjected to firing at a temperature of 500° C. for 2 hours under an oxygen gas atmosphere to remove the polyvinyl alcohol, and then to firing at a temperature of 600° C. for 2 hours under a nitrogen gas atmosphere to join the positive electrode layer, the solid electrolyte layer, and the negative electrode layer by sintering. In this way, a battery laminated body was prepared as a sintered body.

The battery laminated body as a sintered body was dried at a temperature of 100° C. to remove the moisture, and then subjected to sealing with a 2032-type coin cell to prepare a solid-state battery.

### <Evaluation of Solid State Battery>

As a result of charging and discharging the solid-state battery at a constant current and a constant voltage at a current density of 200 μA/cm² in a voltage range of 0 to 2.0 V, it has been confirmed that it is possible to charge and discharge the battery.

It is to be noted that while only the solid-state batteries prepared with the use of metal lithium for the negative electrode or Li₃V₂(PO₄)₃ for the negative electrode active material have been evaluated in Examples 1 to 3, the advantageous effect of the present invention can be achieved even when the negative electrode layer is formed with the use of, as the negative electrode active material, a graphite-lithium compound, a lithium alloy such as Li—Al, a NASICON-type lithium-containing phosphate compound such as Li₃Fe₂(PO₄)₃ other than Li₃V₂(PO₄)₃, or an oxide such as Li₄Ti₅O₁₂, and the present invention is not to be considered limited to the negative electrode active material.

### Comparative Example 1

In Comparative Example 1, in place of the LMO used as the positive electrode active material in Example 1, LiNi_{1/3}Co_{1/3}Mn_{1/3}O₂ was used for a positive electrode active material to prepare compacts of a positive electrode sheet and a solid electrolyte sheet by the same method as in Example 1.

Next, the characteristics of the obtained positive electrode sheet were evaluated in the following way.

### <Evaluation of Positive Electrode Sheet>

An X-ray diffraction pattern for the positive electrode sheet was measured by the same method as in Example 1. FIG. 5 shows the measured X-ray diffraction pattern (LiNi_{1/3}Co_{1/3}Mn_{1/3}O₂+LAGP) for the positive electrode sheet. FIG. 5 together shows an X-ray diffraction pattern for LiNi_{1/3}Co_{1/3}Mn_{1/3}O₂, and an X-ray diffraction pattern for a NASICON-type lithium-germanium containing phosphate compound (LGP: LiGe₂(PO₄)₃).

From FIG. 5, in Comparative Example 1, the X-ray diffraction pattern for the positive electrode sheet as a sintered body fails to agree with the X-ray diffraction patterns for the LiNi_{1/3}Co_{1/3}Mn_{1/3}O₂ and _{LiGe}₂(PO₄)₃, and it is believed that the LiNi_{1/3}Co_{1/3}Mn_{1/3}O₂ and the LiGe₂(PO₄)₃ develop a solid-phase reaction to generate an impurity layer in the positive electrode sheet as a sintered body.

In addition, the thus obtained compacts of the solid electrolyte sheet and positive electrode sheet were used to prepare a solid-state battery by the same method as in Example 1. The evaluation of the obtained solid-state battery resulted in a failure to charge or discharge the battery. This is believed to be because the positive electrode active material and the LAGP as the solid electrolyte developed a solid-phase reaction to generate an impurity layer.

### Comparative Example 2

In Comparative Example 2, in place of the LMO used as the positive electrode active material in Example 1, a lithium cobalt oxide was used for a positive electrode active material to prepare compacts of a positive electrode sheet and a solid electrolyte sheet by the same method as in Example 1.

In addition, the thus obtained compacts of the solid electrolyte sheet and positive electrode sheet were used to prepare a solid-state battery by the same method as in Example 1. The evaluation of the obtained solid-state battery resulted in a failure to charge or discharge the battery. This is believed to be because the positive electrode active material and the lithium cobalt oxide as the solid electrolyte developed a solid-phase reaction to generate an impurity layer.

It is to be noted that a powder including a crystal phase of a NASICON-type lithium-germanium containing oxide, or a glass powder in which a crystal phase of a NASICON-type lithium-germanium containing oxide is deposited by a heat treatment may be used as the powder of the solid electrolyte used in the examples described above.

In addition, the polymer material contained in the slurry for forming the green sheets in the examples described above is not particularly limited, and polyvinyl acetal resins, cellulose resins, acrylic resins, urethane resins, etc. can be used for the polymer material.

The slurry for forming the green sheets can be prepared through a mixing step of mixing an organic vehicle of a polymer material dissolved in a solvent with an inorganic powder in a wet way. In order to achieve high dispersibility of the ceramic powder in the slurry, the organic vehicle is preferably mixed with the ceramic powder with the use of media in the mixing step. While the shape and material of the media are not particularly limited, the mixing is preferably carried out under the condition that a shear force is provided to such an extent that the ceramic powder is not ground by the media, and zirconia spherical media or the like can be used which are 0.2 to 5 mm in grain size. Specifically, a ball mill method, a Viscomilll method, or the like can be used.

In the mixing step described above, a wet mixing method may be used which uses no media, and a sand mill method, a high-pressure homogenizer method, a kneader dispersion method, etc. can be used.

The slurry for forming the green sheets may contain a plasticizer. While the type of the plasticizer is not particularly limited, phthalate esters and the like may be used such as dioctyl phthalate and diisononyl phthalate.

In the slurry preparation step including the mixing step, appropriately, a solvent can be additionally put to make an adjustment into a viscosity suitable for the wet mixing method.

While the methods for forming the green sheets to serve as the positive electrode layer, the negative electrode layer, and the solid electrolyte layer are not particularly limited, a die coater, a comma coater, screen printing, etc. can be used.

While the method for stacking the green sheets is not particularly limited, hot isostatic press, cold isostatic press, warm isostatic press, hydrostatic press etc. can be used.

The embodiments and examples disclosed herein are to be considered by way of example in all respects, but not limiting. The scope of the present invention is defined by the claims, but not by the embodiments or examples described above, and the present invention is intended to encompass all modifications and variations within the spirit and scope equivalent to the scope of the claims.

The use of the NASICON-type lithium-germanium containing compound for the solid electrolyte can provide a rechargeable all solid state secondary battery configured with the use of the spinel-type lithium-containing manganese oxide for the positive electrode active material.

### DESCRIPTION OF REFERENCE SYMBOLS

10: all solid state secondary battery, 11: positive electrode layer, 12: negative electrode layer, 13: solid electrolyte layer

1. An all solid state secondary battery comprising:
a positive electrode layer having a positive electrode active material containing a compound represented by LiₓM_{y}Mn_{z}O₄; and
a solid electrolyte layer adjacent the positive electrode layer and having a solid electrolyte containing a compound represented by Li_{1+w}Al_{w}Ge_{2-w}(PO₄)₃, wherein
1≦x≦1.33,
0≦y≦0.5,
1.67−y≦z≦2−y,
M is at least one element selected from the group consisting of Ni, Co, Al, and Cr, and
0≦w≦1.

2. The all solid state secondary battery according to claim 1, wherein the compound contained in the positive electrode active material is LiMn₂O₄.

3. The all solid state secondary battery according to claim 1, wherein the compound contained in the positive electrode active material is LiNi_{0.5}Mn_{1.5}O₄.

4. The all solid state secondary battery according to claim 1, wherein the positive electrode layer and the solid electrolyte layer are joined by sintering.

5. The all solid state secondary battery according to claim 1, wherein the positive electrode active material contains at least one metal selected from the group consisting of aluminum, yttrium, gallium, indium, and lanthanum.

6. The all solid state secondary battery according to claim 1, wherein the solid electrolyte contains silicon.

7. The all solid state secondary battery according to claim 1, further comprising a negative electrode layer adjacent the solid electrolyte layer.

8. The all solid state secondary battery according to claim 7, wherein the negative electrode layer comprises a metal lithium.

9. The all solid state secondary battery according to claim 7, wherein the negative electrode includes a negative electrode active material.

10. The all solid state secondary battery according to claim 9, wherein the negative electrode active material is selected from the group consisting of a graphite-lithium compound, a lithium alloy, a NASICON-type lithium-containing phosphate compound, and a lithium oxide.

11. A method for producing an all solid state secondary battery, the method comprising:
forming a positive electrode layer containing, as a positive electrode active material, a compound represented by LiₓM_{y}Mn_{z}O₄, wherein 1≦x≦1.33, 0≦y≦0.5, 1.67−y≦z≦2−y, and M is at least one element selected from the group consisting of Ni, Co, Al, and Cr;
forming a solid electrolyte layer containing a compound represented Li_{1+w}Al_{w}Ge_{2-w}(PO₄)₃, wherein 0≦w≦1;
stacking the positive electrode layer and the solid electrolyte layer; and
joining the positive electrode layer and the solid electrolyte layer by sintering.

12. The method for producing an all solid state secondary battery according to claim 11, wherein the positive electrode layer and the solid electrolyte layer are joined by sintering at a temperature of 500° C. or more and 700° C. or less.

13. The method for producing an all solid state secondary battery according to claim 11, wherein the compound contained in the positive electrode active material is LiMn₂O₄.

14. The method for producing an all solid state secondary battery according to claim 11, wherein the compound contained in the positive electrode active material is LiNi_{0.5}Mn_{1.5}O₄.

15. The method for producing an all solid state secondary battery according to claim 11, wherein the positive electrode active material contains at least one metal selected from the group consisting of aluminum, yttrium, gallium, indium, and lanthanum.

16. The method for producing an all solid state secondary battery according to claim 11, wherein the solid electrolyte contains silicon.

17. The method for producing an all solid state secondary battery according to claim 11, further comprising forming a negative electrode layer on a surface of the solid electrolyte layer opposite the positive electrode layer.

18. The method for producing an all solid state secondary battery according to claim 17, wherein the negative electrode layer comprises a metal lithium.

19. The method for producing an all solid state secondary battery according to claim 17, wherein the negative electrode includes a negative electrode active material.

20. The method for producing an all solid state secondary battery according to claim 19, wherein the negative electrode active material is selected from the group consisting of a graphite-lithium compound, a lithium alloy, a NASICON-type lithium-containing phosphate compound, and a lithium oxide.
